(19) United States
(12) Patent Application Publication
(10) Pub. No.: US 2006/0239231 A1
(43) Pub. Date: Oct. 26, 2006

(54) Method for enhancing voice call reception rate in mobile communication terminal

(75) Inventor: Kwang-Sik Hong, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/409,158

(22) Filed: Apr. 21, 2006

(30) Foreign Application Priority Data
Apr. 22, 2005 (KR) 10-2005-0033763

(51) Int. Cl. H04Q 7/00

(52) U.S. Cl. 370/331

(57) ABSTRACT

A method for enhancing a voice call reception rate in a mobile communication terminal is provided. Voice call reception is enhanced by selectively limiting idle handoff generation by setting idle handoff occurrence conditions to be more difficult if an idle handoff from the first base station to the second base station accompanies a packet zone reconnection procedure and/or by performing the packet zone reconnection only when the mobile communication terminal remains in a zone of the second base station for a predetermined time if the handoff between the first base station and the second base station is necessary.

### CROSS-REFERENCE TO RELATED APPLICATIONS

Pursuant to 35 U.S.C. §119(a), this application claims the benefit of earlier filing date and right of priority to Korean Application No. 10-2005-0033763, filed on Apr. 22, 2005, the contents of which is hereby incorporated by reference herein in its entirety

### BACKGROUND OF THE INVENTION

1. Field of the Invention

The present invention relates to a CDMA digital cellular telephony system, and more particularly, to a method for enhancing a voice call reception rate in a mobile communication terminal when packet zone (cell or group of cells) changes occur.

2. Description of the Related Art

In a CDMA digital cellular telephony system, when a mobile communication terminal using 1× data service is in a dormant state, a packet zone, a system ID (SID) or a network ID (NID) can be changed. When the packet zone changes, the mobile communication terminal performs an idle handoff according to a new base station by originating a call for packet zone reconnection in order to establish a data service path for a new packet zone according to an IS-707 specification.

FIG. 1 is a flowchart showing an idle handoff and a packet zone reconnection procedure in accordance with the related art. As illustrated in FIG. 1, when a user of a mobile communication terminal is located at a packet zone boundary, the mobile communication terminal measures a pilot signal strength (P_BS1) of a base station BS1 (S10), compares the P_BS1 and a threshold value (th1) with a pilot signal strength (P_BS2) of a base station BS2 which is part of a current active set (AS) (S11) and determines whether or not to perform an idle handoff according to formula (1).
P_{—}BS1+th1<P_{—}BS2 formula (1)

When formula (1) is satisfied, the mobile communication terminal performs an idle handoff to the BS2 (S12) and the BS2 becomes an active set in an idle state. When formula (1) is not satisfied, the mobile communication terminal remains in communication with BS1 (S13).

If the threshold value (th1) in formula (1) is small, idle handoffs from BS1 to BS2 occur too frequently. If the threshold value (th1) is set larger in order to prevent unnecessary idle handoffs, the frequent occurrence of idle handoffs can be reduced but idle handoffs may be too limited. Accordingly, it is necessary to appropriately set the threshold (th1) value.

When formula (1) is satisfied and the mobile communication terminal performs idle handoff to the BS2, the mobile communication terminal checks whether it is in a dormant state of the 1× data service (S14). If the mobile communication terminal is in the dormant state, it checks whether packet zone reconnection is needed due to changes in a packet zone ID or an SID (or an NID) according to the IS-707 specification (S15). That is, the mobile communication terminal checks whether the BS2 is a base station that should perform a packet zone reconnection by comparing a packet zone ID of the BS1 with a packet zone ID of the BS2.

If reconnection is necessary, the mobile communication terminal sends a 1× data call by using a service option (SO=33) and performs a negotiation procedure with respect to the BS2 in a traffic state to set a data path in a new packet zone (S17). Then, the mobile communication terminal maintains an idle state by utilizing the BS2 as an active set of an idle state (S19).

If the mobile communication terminal is not in the dormant state or the packet zone reconnection is not necessary, the mobile communication terminal checks whether registration is necessary (S16). If registration is necessary, the mobile communication terminal performs registration by using an access channel (S18) and then maintains the BS2 as an active set of an idle state (S19). If registration is not necessary, the mobile communication terminal maintains the BS2 as an active set of an idle state (S19).

However, in the related art, while the mobile communication terminal originates a call for packet zone reconnection according to an idle handoff, any received incoming voice calls are automatically sent to a voice mail feature or can not be received, thereby resulting in a degradation in a call reception rate of the mobile communication terminal. For example, a voice call reception rate may be degraded due to a mobile communication terminal performing packet zone reconnection for several reasons:

1) The mobile communication terminal cannot receive paging while sending a call (or call origination).

2) When a base station provides only acknowledgement (ACK) for an origination (call sending) from the mobile communication terminal but does not provide a channel allocation message thereafter, the mobile communication terminal ignores a received paging message for a certain time duration, such as 12 seconds. Therefore, the received paging message is sent to the voice mail feature.

3) When the base station sends the acknowledgement (ACK) and then sends a release order, the mobile communication terminal returns to its initial state. Therefore, a paging error may be generated while a base station signal is being searched.

4) While the mobile communication terminal performs a packet zone reconnection, the mobile communication terminal is in a traffic state. Therefore, any incoming call signals are sent to the voice mail feature.

5) If the mobile communication terminal does not receive an access for a reconnection from the base station, the mobile communication terminal attempts another call origination (call sending). During this period, there is a high possibility that the mobile communication terminal will not receive paging messages.

Generally, signal strength is not only weak but also changes severely due to wireless fading effects at a cell (base station) boundary where a packet zone changes. Accordingly, an idle handoff ping-pong phenomenon, whereby idle handoff of the mobile communication terminal is alternately performed between two base stations, may occur.

No function currently exists in the related art for limiting frequent packet zone reconnections. Therefore, whenever an event requiring packet zone reconnection occurs, the mobile communication terminal performs a call origination (sending) to perform reconnection.

If the reconnection of the mobile communication terminal is frequently performed when idle handoff is alternately performed between two base stations at the cell (base station) boundary, further degradation of a voice call reception rate results. Furthermore, the frequent reconnection of the mobile communication terminal causes the base station to consume resources of a reverse access channel and a traffic channel, as well as causing greater power consumption in the mobile communication terminal. As a result, the base station cannot properly allocate calling channels to other users due to the increase of a system load caused by frequent calling channel allocation.

Therefore, there is a need for a method for enhancing a voice call reception rate when a packet zone change occurs. The present invention addresses this and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

An object of the present invention is to reduce frequency of call origination for a packet zone reconnection by setting proper idle handoff occurrence conditions. Another object of the present invention is to reduce a frequency of call origination for a packet zone reconnection by applying a time limit to a packet zone reconnection procedure.

In one aspect of the present invention, a method for enhancing a voice call reception rate in a mobile communication terminal when performing an idle handoff according to a change of a packet zone is provided. The method includes determining that an idle handoff from a first base station to a second base station in a dormant state of a 1× data service requires a packet zone reconnection and limiting initiation of the idle handoff by setting more stringent conditions for a comparison between a signal strength from the first base station and a signal strength from the second base station and/or initiating the packet zone reconnection only if the mobile communication terminal remains in a the packet zone corresponding to the second base station for a predetermined period of time.

It is contemplated that limiting initiation of the idle handoff includes adding an offset value to a measured signal strength of the first base station. It is further contemplated that limiting initiation of the idle handoff further includes adding the offset value only if it is determined that overhead information of the second base station exists in an internal memory.

It is contemplated that limiting initiation of the idle handoff further includes performing the idle handoff only when the signal strength from the second base station is greater than or equal to a value determined by the signal strength from the first base station added to a threshold value and the offset value. It is further contemplated that initiating the packet zone reconnection includes determining that the idle handoff is necessary based on a comparison of the signal strength of the first base station and a signal strength of the second base station, generating and storing a reconnection request, initializing a timer, determining if the mobile communication terminal is still in the packet zone corresponding to the second base station and sending the stored reconnection request only if the mobile communication terminal remains in the packet zone corresponding to the second base station until the timer expires.

It is contemplated that determining that the idle handoff is necessary includes performing the idle handoff only when the signal strength from the second base station is greater than or equal to a value determined by the signal strength from the first base station added to a threshold value and the offset value. Preferably, the method further includes determining that overhead information of the second base station exists in an internal memory. It is further contemplated that determining that the idle handoff is necessary includes performing the idle handoff only when the signal strength from the second base is greater than or equal to a value determined by the signal strength from the first base station added to a threshold value.

In another aspect of the present invention, a method for enhancing a voice call reception rate in a mobile communication terminal when performing an idle handoff according to a change of a packet zone is provided. The method includes determining that overhead information of a neighboring base station exists in an internal memory, determining that the mobile communication terminal is in a dormant state of a 1× data service, determining that an idle handoff from a current base station to the neighboring base station requires a packet zone reconnection, the current base station corresponding to a packet zone in which the mobile communication terminal is currently located, and limiting initiation of the idle handoff by setting more stringent conditions for a comparison between a signal strength from the current base station and a signal strength from the neighboring base station.

It is contemplated that limiting initiation of the idle handoff includes adding an offset value to a measured signal strength of the current base station. It is further contemplated that limiting initiation of the idle handoff further includes performing the idle handoff only when the signal strength from the neighboring base is greater than or equal to a value determined by the signal strength from the current base station added to a threshold value and the offset value.

In another aspect of the present invention, a method for enhancing a voice call reception rate in a mobile communication terminal when performing an idle handoff according to a change of a packet zone is provided. The method includes determining that the idle handoff is necessary based on a comparison of a signal strength of a current base station and a signal strength of a neighboring base station, the current base station corresponding to a packet zone in which the mobile communication terminal is currently located, determining that the mobile communication terminal is in a dormant state of a 1× data service, determining that a packet zone reconnection to the neighboring base station is necessary, generating and storing a reconnection request, initializing a timer, determining if the mobile communication terminal is still in the packet zone corresponding to the second base station and sending the stored reconnection request only if the mobile communication terminal remains in the packet zone corresponding to the neighboring base station until the timer expires.

It is contemplated that determining that the idle handoff is necessary includes performing the idle handoff only when the signal strength from the neighboring base is greater than or equal to a value determined by the signal strength from the current base station added to a threshold value and an offset value. Preferably, determining that the idle handoff is necessary further includes determining that overhead information of the neighboring base station exists in an internal memory. It is further contemplated that determining that the idle handoff is necessary includes performing the idle handoff only when the signal strength from the neighboring base is greater than or equal to a value determined by the signal strength from the current base station added to a threshold value.

The foregoing and other objects, features, aspects and advantages of the present invention will become more apparent from the following detailed description of the present invention when taken in conjunction with the accompanying drawings. Additional features and advantages of the invention will be set forth in the description which follows, and in part will be apparent from the description, or may be learned by practice of the invention.

It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flowchart illustrating a conventional method for determining an idle handoff and a packet zone reconnection.

FIG. 2 is a flowchart illustrating a method for enhancing a voice call reception rate according to a first embodiment of the present invention.

FIG. 3 is a flowchart illustrating a method for enhancing a voice call reception rate according to a second embodiment of the present invention.

### DETAILED DESCRIPTION OF THE PREFERRED EMBODIMENTS

The present invention relates to an apparatus and method for enhancing a voice call reception rate when a mobile communication terminal packet zone changes. Although the present invention is illustrated with respect to a CDMA digital cellular telephony system, it is contemplated that the present invention may be applied to a wireless communication system operated according to other technical specifications.

Reference will now be made in detail to the preferred embodiments of the present invention, examples of which are illustrated in the accompanying drawings. The present invention proposes a method for reducing a phenomenon whereby a mobile communication terminal does not receive a voice call due to a packet zone reconnection generated by a change of a packet zone ID when a data service is in a dormant state in a CDMA digital cellular telephony system.

A method for enhancing a voice call reception rate according to a first embodiment of the present invention prevents an idle handoff ping-pong phenomenon that occurs when signal strength is varied at a cell boundary where a packet zone is changed. The method reduces a call origination for a packet zone reconnection by setting proper idle handoff occurrence conditions for an idle handoff that is anticipated to accompany a packet zone reconnection procedure. According to the method, frequent packet zone reconnections are reduced, thereby enhancing a voice call reception rate.

A method for enhancing a voice call reception rate according to a second embodiment of the present invention utilizes a timer (T42 timer). According to the method, a request for reconnection after an idle handoff is stored, or reserved, in a queue and the reconnection is performed only when the mobile communication terminal remains in a zone of a new base station for a certain amount of time.

If the mobile communication terminal performs an idle handoff to the original base station before the certain time lapses, the mobile communication terminal cancels the reserved reconnection request. A time limit is applied to a packet zone reconnection generation according to a frequency of idle handoff in order to enhance a call reception rate.

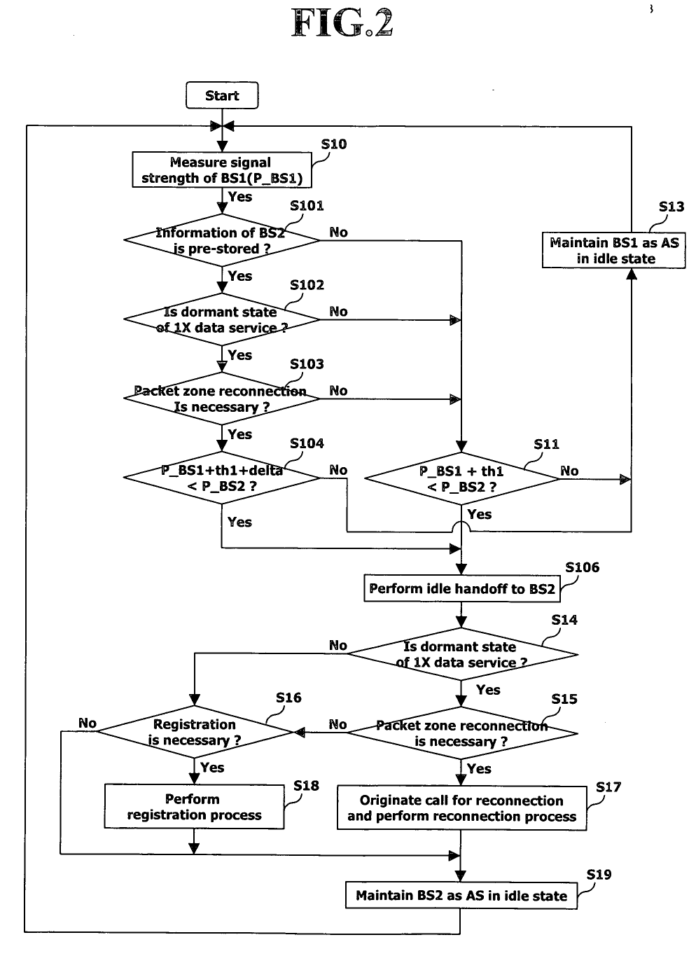

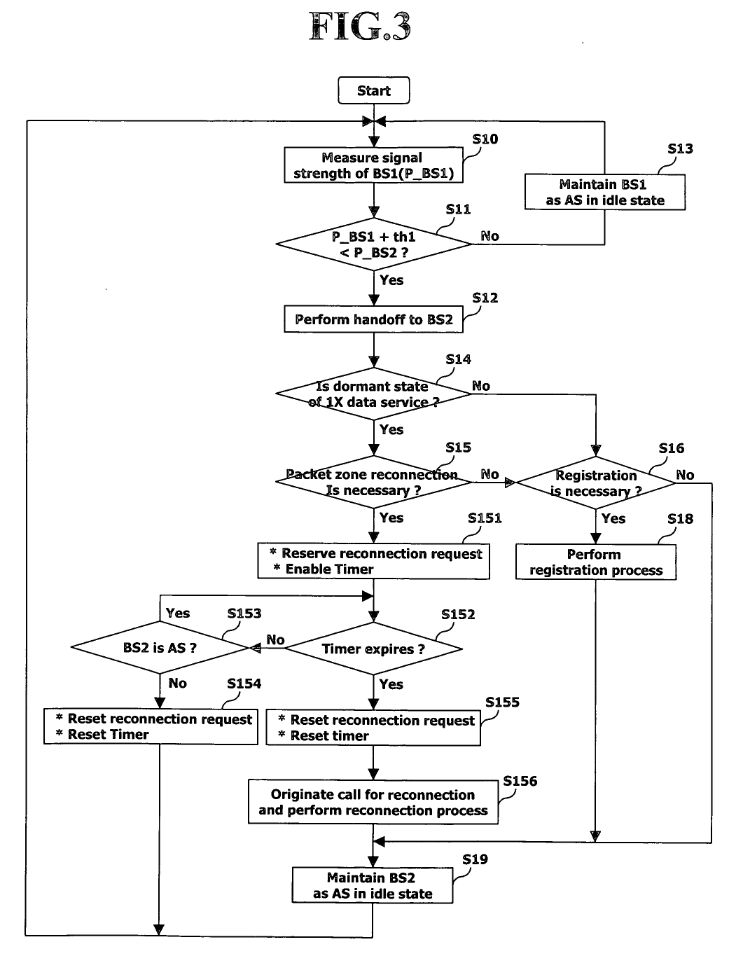

The method for enhancing a call reception rate according to the first and second embodiment of the present invention will be explained in more detail with reference to the attached drawings. FIG. 2 is a flowchart illustrating a method for enhancing a voice call reception rate according to the first embodiment of the present invention. FIG. 3 is a flowchart illustrating a method for enhancing a voice call reception rate according to a second embodiment of the present invention.

Generally, a mobile communication terminal stores information of a base station that the mobile communication terminal has visited, for example, after having entered a cell region managed by the base station. The present invention can be applied when the mobile communication terminal stores overhead information of the base station in an internal memory.

For example, the present invention can be applied when the mobile communication terminal has visited a new base station BS2 or when the idle handoff of the mobile communication terminal at a cell boundary between two base stations, BS1 and BS2, is performed in order to address the aforementioned a ping-pong phenomenon. If the mobile communication terminal has visited BS2, the mobile communication terminal determines whether BS2 is a base station for which a packet zone reconnection must be performed after idle handoff. The determination is performed by using pre-stored system information related to BS2 without reading an overhead message in a paging channel of BS2, or in other words, before performing the idle handoff.

As illustrated in FIG. 2, the mobile communication terminal measures pilot signals of neighbor sets (NS) at the cell boundary in order to measure a signal size of BS1 (P_BS1) (S100). The mobile communication terminal then checks whether overhead information related to BS2 exists in an internal memory (S101).

If overhead information related to BS2 exists in the internal memory of the mobile communication terminal and the mobile communication terminal is in a dormant state of a 1× data service (S102), the mobile communication terminal determines whether BS2 is a base station for which a packet zone reconnection is necessary (S103). The determination is performed by a comparison between a stored packet zone ID (PACKET_ZONE_ID) of BS2 and a packet zone ID of BS1, which is a current active set (AS). If a system ID (SID) or a network ID (NID) is changed, the packet zone reconnection is performed.

If the packet zone reconnection for BS2 is necessary, the mobile communication terminal compares a measured signal size of BS1 (P_BS1) and a threshold value (th2) with a pre-stored signal size of BS2 (P_BS2) using an offset (delta) to determine whether to perform an idle handoff. The comparison is performed according to formula (2) (S104).
P_{—}BS1+th1+delta<P_{—}BS2 formula (2)

If formula (2) is satisfied, the mobile communication terminal performs an idle handoff to BS2 (S106) and BS2 becomes an active set in an idle state. If formula (2) is not satisfied, the mobile communication terminal remains with BS1 (S107).

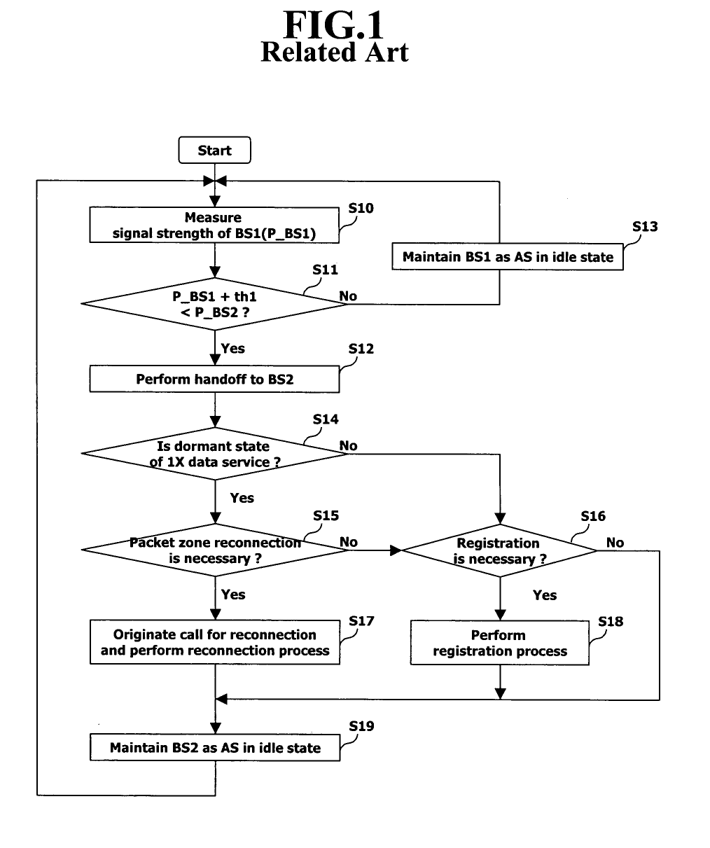

The operation after step S106 is the same as that of the conventional method. Therefore, the same reference descriptions are used as in FIG. 1 and a detailed description is omitted.

If overhead information related to BS2 does not exist in the internal memory of the mobile communication terminal, if the mobile communication terminal does not use a 1× data service or if BS2 does not require packet zone reconnection, the mobile communication terminal follows the conventional method for forming an idle handoff according to formula (1). The subsequent operation is the same as that of the conventional method and, therefore, the same reference descriptions are used as in FIG. 1 and a detailed description is omitted.

According to the first embodiment of the present invention, less idle handoffs are performed, thereby reducing call origination (sending) for reconnection. When the call origination for reconnection is reduced, a voice termination signal to the mobile communication terminal is not easily missed, thereby enhancing a voice call reception rate.

The first embodiment of the present invention is applied when the 1× packet data service is in a dormant state. Handoff is performed using the conventional formula (1) when the 1× packet data service is not in a dormant state. Since idle handoff is reduced only when necessary, disadvantages can be reduced.

In the second embodiment of the present invention, after determining that a packet zone reconnection must be performed, the mobile communication terminal does not immediately originate (send) a call by using the service option (SO) 33. Instead, the mobile communication terminal originates (sends) a call to the SO33 after a predetermined time.

Generally, the signal strength is weak and may change severely due to wireless fading at a cell (base station) boundary where a packet zone changes. Accordingly, an idle handoff ping-pong phenomenon may occur, whereby an idle handoff of the mobile communication terminal is alternately performed between two base stations. If a packet zone reconnection is frequently performed when the idle handoff is alternately performed between two base stations, an incoming call signal is automatically sent to a voice mail feature, thereby degrading a call reception rate.

In order to limit the alternation of the idle handoff, packet zone reconnection is performed according to the second embodiment only when the mobile communication terminal remains in a zone of BS2 for a predetermined amount of time after idle handoff is performed. FIG. 3 is a flowchart illustrating a method for enhancing a voice call reception rate according to the second embodiment of the present invention.

As illustrated in FIG. 3, the conventional process is performed up to the point that it is determined that a reconnection to BS2 is necessary and, therefore, the same reference destinations are used as in FIG. 1 and a detailed description is omitted. Once it is determined that reconnection to BS2 is necessary, the mobile communication terminal sets a request for the reconnection and then enables a timer in order to limit a call origination (sending) procedure for the reconnection (S151).

If the timer 1 expires (S209), the mobile communication terminal resets the reconnection request and the timer (S155). Then, the mobile communication terminal performs a call origination (sending) for the reconnection (S156) and maintains BS2 as an active set (AS) of an idle state (S156).

If the timer has not expired, the mobile communication terminal checks whether BS2 is still the active set (AS) (S153). If BS2 is not the AS, due to, for example, the mobile communication terminal moving to another base station region or the mobile communication terminal being in a no service state, the mobile communication terminal resets the set reconnection request and the timer (S154). Then, the mobile communication terminal again performs the conventional method for idle handoff to a new base station. If BS2 is still the active set (AS), the mobile communication terminal continues to monitor the timer (S152).

In the first embodiment of the present invention, an idle handoff procedure that is anticipated to generate a packet zone reconnection is made more difficult than in a conventional idle handoff procedure. When the packet zone reconnection is required, a reconnection attempt is deferred for a predetermined amount of time according to the second embodiment of the present invention, whereby reconnection is initiated only after determining that a new candidate base status remains the active set (AS).

Accordingly, in the first and second embodiments of the present invention, if a proper delta offset value and a timer timeout time are set, a voice call reception rate can be enhanced without degrading a function of an IX data service call. The first embodiment and the second embodiment of the present invention can be applied individually or together in a mobile communication terminal.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds, are intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for enhancing a voice call reception rate in a mobile communication terminal when performing an idle handoff according to a change of a packet zone, the method comprising:
determining that an idle handoff from a first base station to a second base station in a dormant state of a 1× data service requires a packet zone reconnection; and
at least one of limiting initiation of the idle handoff by setting more stringent conditions for a comparison between a signal strength from the first base station and a signal strength from the second base station and initiating the packet zone reconnection only if the mobile communication terminal remains in a the packet zone corresponding to the second base station for a predetermined period of time.

2. The method of claim 1, wherein limiting initiation of the idle handoff comprises adding an offset value to a measured signal strength of the first base station.

3. The method of claim 2, wherein limiting initiation of the idle handoff further comprises adding the offset value only if it is determined that overhead information of the second base station exists in an internal memory.

4. The method of claim 2, wherein limiting initiation of the idle handoff further comprises performing the idle handoff only when the signal strength from the second base station is greater than or equal to a value determined by the signal strength from the first base station added to a threshold value and the offset value.

5. The method of claim 1, wherein initiating the packet zone reconnection comprises:
determining that the idle handoff is necessary based on a comparison of the signal strength of the first base station and a signal strength of the second base station;
generating and storing a reconnection request;
initializing a timer;
determining if the mobile communication terminal is still in the packet zone corresponding to the second base station; and
sending the stored reconnection request only if the mobile communication terminal remains in the packet zone corresponding to the second base station until the timer expires.

6. The method of claim 5, wherein determining that the idle handoff is necessary comprises performing the idle handoff only when the signal strength from the second base station is greater than or equal to a value determined by the signal strength from the first base station added to a threshold value and the offset value.

7. The method of claim 6, further comprising determining that overhead information of the second base station exists in an internal memory.

8. The method of claim 5, wherein determining that the idle handoff is necessary comprises performing the idle handoff only when the signal strength from the second base is greater than or equal to a value determined by the signal strength from the first base station added to a threshold value.

9. A method for enhancing a voice call reception rate in a mobile communication terminal when performing an idle handoff according to a change of a packet zone, the method comprising:
determining that overhead information of a neighboring base station exists in an internal memory;
determining that the mobile communication terminal is in a dormant state of a 1× data service;
determining that an idle handoff from a current base station to the neighboring base station requires a packet zone reconnection, the current base station corresponding to a packet zone in which the mobile communication terminal is currently located; and
limiting initiation of the idle handoff by setting more stringent conditions for a comparison between a signal strength from the current base station and a signal strength from the neighboring base station.

10. The method of claim 9, wherein limiting initiation of the idle handoff comprises adding an offset value to a measured signal strength of the current base station.

11. The method of claim 10, wherein limiting initiation of the idle handoff further comprises performing the idle handoff only when the signal strength from the neighboring base is greater than or equal to a value determined by the signal strength from the current base station added to a threshold value and the offset value.

12. A method for enhancing a voice call reception rate in a mobile communication terminal when performing an idle handoff according to a change of a packet zone, the method comprising:
determining that the idle handoff is necessary based on a comparison of a signal strength of a current base station and a signal strength of a neighboring base station, the current base station corresponding to a packet zone in which the mobile communication terminal is currently located;
determining that the mobile communication terminal is in a dormant state of a 1× data service;
determining that a packet zone reconnection to the neighboring base station is necessary;
generating and storing a reconnection request;
initializing a timer;
determining if the mobile communication terminal is still in the packet zone corresponding to the second base station; and
sending the stored reconnection request only if the mobile communication terminal remains in the packet zone corresponding to the neighboring base station until the timer expires.

13. The method of claim 12, wherein determining that the idle handoff is necessary comprises performing the idle handoff only when the signal strength from the neighboring base is greater than or equal to a value determined by the signal strength from the current base station added to a threshold value and an offset value.

14. The method of claim 13, wherein determining that the idle handoff is necessary further comprises determining that overhead information of the neighboring base station exists in an internal memory.

15. The method of claim 12, wherein determining that the idle handoff is necessary comprises performing the idle handoff only when the signal strength from the neighboring base is greater than or equal to a value determined by the signal strength from the current base station added to a threshold value.
